(19) United States
(12) Patent Application Publication
(10) Pub. No.: US 2010/0201165 A1
(43) Pub. Date: Aug. 12, 2010

(54) ERGONOMIC WORK STATION

(76) Inventor: James Dankovich, Troy, MI (US)

Correspondence Address: HOWARD & HOWARD ATTORNEYS PLLC, 450 West Fourth Street, Royal Oak, MI, 48067, US

(21) Appl. No.: 12/764,139

(22) Filed: Apr. 21, 2010

Related U.S. Application Data
(63) Continuation-in-part of application No. 12/596,960, filed on Mar. 31, 2010.
(60) Provisional application No. 60/926,058, filed on Apr. 24, 2007.
(60) Provisional application No. 60/932,877, filed on Jun. 1, 2007.
(60) Provisional application No. 60/992,614, filed on Dec. 5, 2007.

(51) Int. Cl. A47B 83/02; A47C 7/54; A47C 7/38; F16M 11/18

(52) U.S. Cl. 297/135; 248/398

(57) ABSTRACT

A work station comprises a base. A seat and a tower are each cooperatively connected to the base thereby providing an adjustable interaction between the seat and the tower. The tower supports a keyboard support and the seat has an armrest for supporting an occupant. At least one armrest adjustment device is disposed between the seat and the armrest and is moveable between an unlocked position to allow for adjustment of the armrest relative to the seat to an ergonomically correct position relative to the keyboard support and to a locked position to lock the armrest in the ergonomically correct position. An armrest lever is operatively connected to the at least one armrest adjustment device to move the at least one armrest adjustment device between the unlocked position and the locked position.

### CROSS-REFERENCE TO RELATED APPLICATIONS

This patent application is a continuation-in-part of and claims priority to and all advantages of U.S. patent application Ser. No. 12/596,960 filed on Oct. 21, 2009, which claims priority to International Application No. PCT/US2008/005306 filed on Apr. 24, 2008, which claims priority to U.S. Provisional Patent Application Nos. 60/926,058 filed on Apr. 24, 2007, 60/932,877 filed on Jun. 1, 2007, and 60/992,614 filed on Dec. 5, 2007.

### BACKGROUND OF THE INVENTION

1. Field of the Invention

The present invention generally relates to a work station having a seat and a tower that cooperate to provide an ergonomically correct posture for an occupant of the seat.

2. Description of the Related Art

Computers have become an integral part in the daily lives of many people for both work purposes and recreational purposes. Many people spend several hours each day seated in a chair in front of a table or desk that supports the computer. However, the table or desk used to support the computer and the chairs used to support the user provide inadequate support for the user. This results in poor posture, which leads to fatigue, chiropractic problems, and other medical conditions.

Improper position and spacing of the seat and a monitor of the computer causes the user to lean in awkward positions and/or to slump forward in the seat for extended periods of time leading to neck and back fatigue. By repeatedly assuming such awkward positions for extended periods of time, the user is also subject to long term neck, back, thoracic, and lumbo-pelvic strain.

Further, improper position and spacing of armrests of the seat and a keyboard of the computer causes the user to hold his/her arms and wrists in uncomfortable positions. These uncomfortable positions not only cause fatigue but can also cause long term medical conditions, especially to the wrists, forearm, elbows, shoulders, etc. Accordingly, it would be advantageous to manufacture a work station that supports the components of the computer and supports the user in a relative position to provide an ergonomically correct posture to the user.

### SUMMARY OF THE INVENTION AND ADVANTAGES

A work station comprises a base. A seat and a tower are each cooperatively connected to the base thereby providing an adjustable interaction between the seat and the tower. The tower supports a keyboard support and the seat has an armrest for supporting an occupant. At least one armrest adjustment device is disposed between the seat and the armrest and are moveable between an unlocked position to allow for adjustment of the armrest relative to the seat to an ergonomically correct position relative to the keyboard support and to a locked position to lock the armrest in the ergonomically correct position. An armrest lever is operatively connected to the at least one armrest adjustment device to move the at least one armrest adjustment device between the unlocked position and the locked position.

Also, a work station comprises a track and a tower coupled to the track and including apparatus for supporting components of a computer including at least one of a monitor support and a keyboard support. A seat is operatively coupled to the track to move along the track toward the tower to a proximate position and away from the tower to a distal position. The seat is rotatable about an axis extending transversely to the track. The track includes a first section and a second section ramping downwardly from the first section toward the tower such that the first section supports the seat in the distal position and such that the second section biases the seat toward the proximate position when the seat is moved along the track to the second section.

The ergonomically correct posture provided by the cooperation between the seat and the tower reduces muscle fatigue, chiropractic problems, and other medical conditions associated with improper posture. Also, since the armrest is adjustable relative to the keyboard support, the armrest can be adjusted such that, when the occupant rests his/her arms on the armrest, the occupant's hands are naturally resting on a keyboard supported by the keyboard support in an ergonomically correct posture. This orientation reduces muscle fatigue in the occupant's wrists because the occupant need not stretch or hold his/her wrists in an awkward position to reach the keyboard support. This orientation also reduces neck and back fatigue because the occupant need not lean his/her neck and/or back to properly reach the keyboard support.

Also, since the seat is biased to the proximate position, the occupant is selectively maintained in the proximate position so that the occupant is properly spaced from the tower. Accordingly, the occupant is urged toward the proximate position so that the occupant can adjust the rest of the work station to provide an ergonomically correct posture. Also, the occupant need not readjust the relative position of the seat and the tower while seated in the seat. Further, the occupant need not expel energy maintaining the seat in the proximate position.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a work station;

FIG. 2 is a side view of the work station with a seat in a distal position;

FIG. 3 is a side view of the work station with the seat in a proximate position;

FIG. 3A is a side view of another embodiment of the work station in a collapsed position;

FIG. 4 is a top view of the work station;

FIG. 5 is a perspective view of an armrest of the seat;

FIG. 6 is a side view of the armrest;

FIG. 7 is a side view of a headrest of the seat;

FIG. 8 is a perspective view of the headrest; and

FIG. 9 is another perspective view of the headrest.

### DETAILED DESCRIPTION OF THE INVENTION

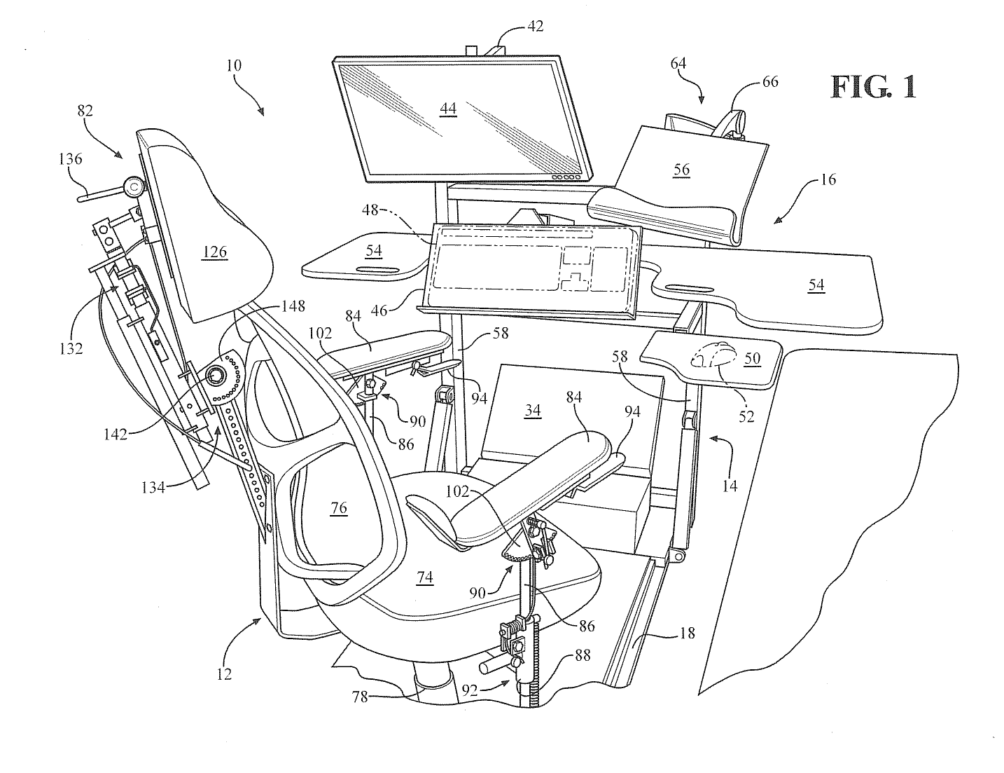

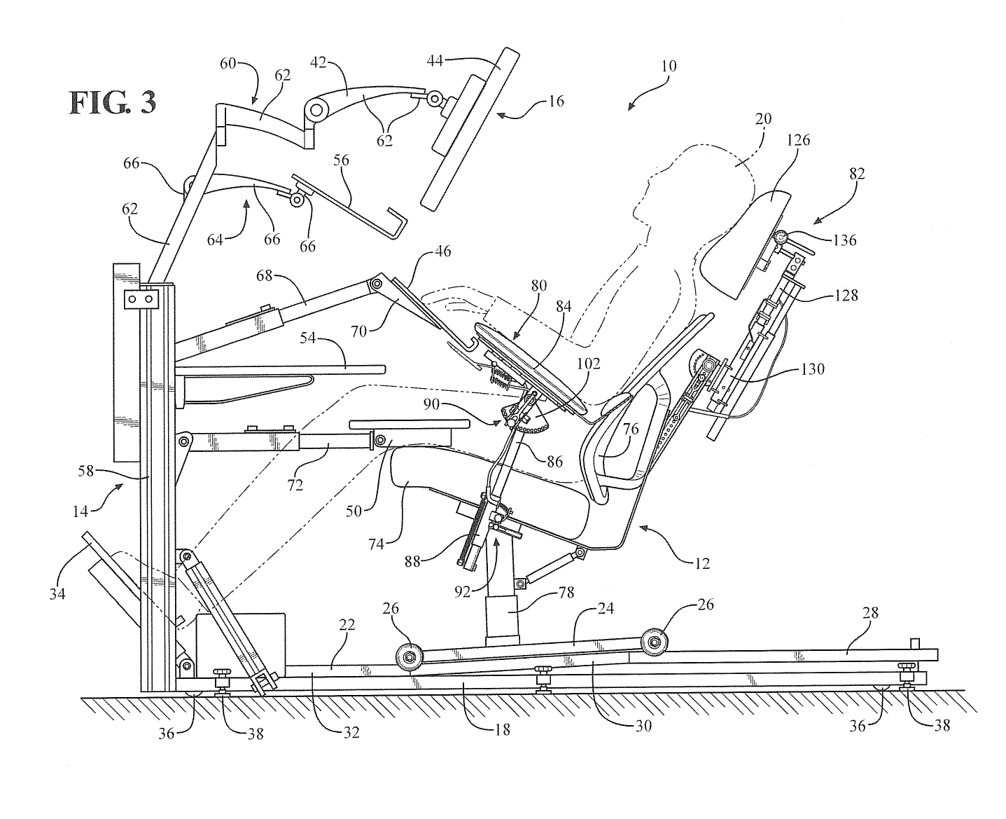

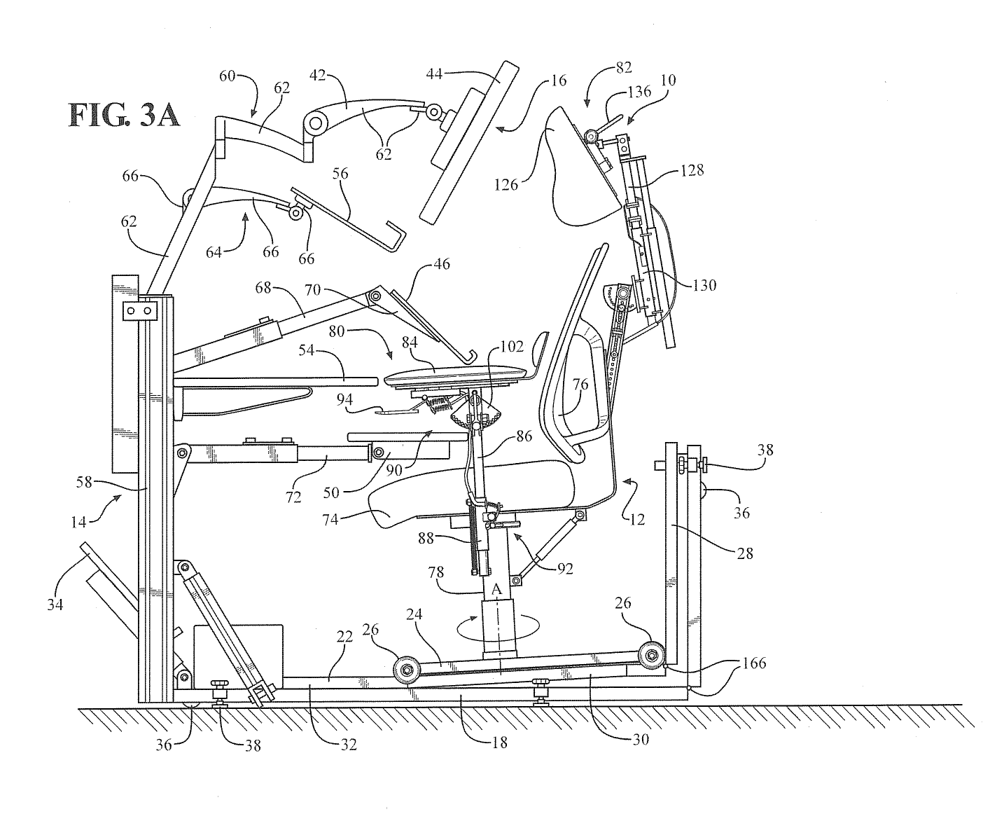

Referring to the Figures, wherein like numerals indicate like parts throughout the several views, a work station is generally shown at 10. With reference to FIG. 1, the work station 10 includes a seat 12 for supporting an occupant 20 (shown in FIG. 3) and a tower 14 including apparatus 16 for supporting components of a computer. The work station 10 also includes a base 18 coupling the seat 12 and the tower 14. As set forth further below, the seat 12 and the tower 14 allow for multiple position adjustments by an occupant 20 while the occupant 20 is seated in the seat 12 for providing ergonomically correct posture to the occupant 20, i.e., the work station 10 is adjusted to an ergonomically correct position. The ergonomically correct position is one in which the occupant has a relaxed and unstrained posture. The work station 10 can be used, for example, in an office environment, for personal use, such as in a home, or for gambling in a casino. The computer can be, for example, a personal computer, a laptop, or a gaming system.

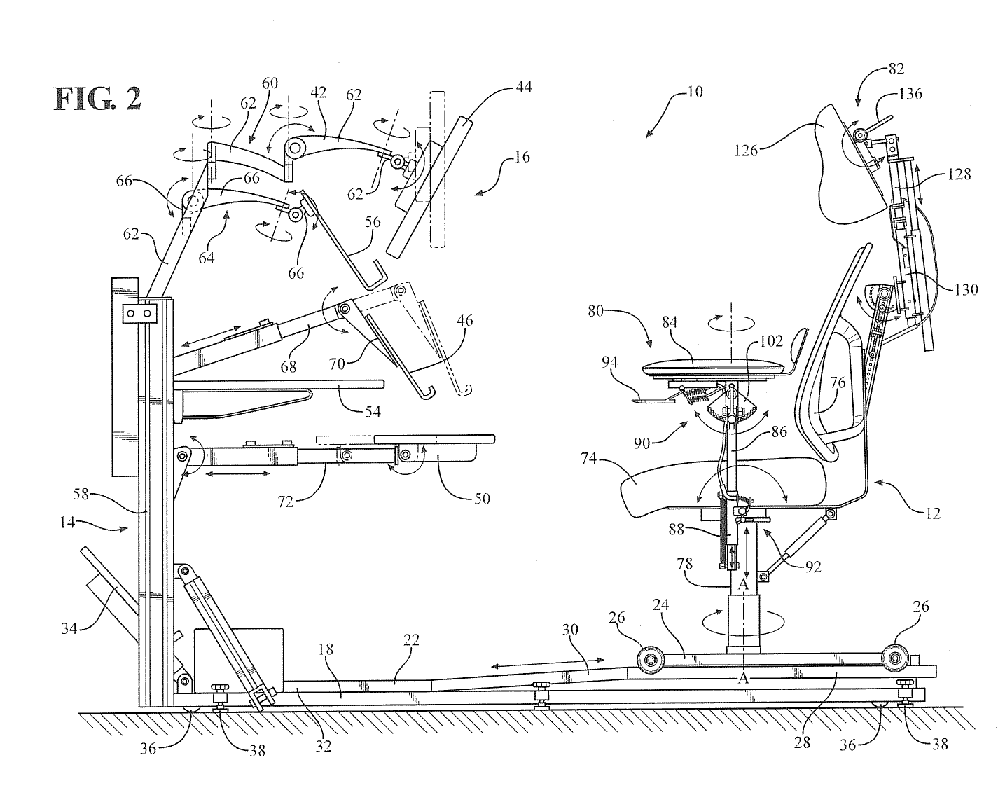

With reference to FIGS. 2-4, the seat 12 and the tower 14 are each cooperatively connected to the base 18 thereby providing an adjustable interaction between the seat 12 and the tower 14. In other words, the seat 12 and the tower 14 can be moved toward and away from each other. Typically, the tower 14 is fixed in position relative to the base 18 and the seat 12 is moveable along the base 18 toward and away from the tower 14 as shown in FIGS. 2 and 3. Alternatively, the tower 14 can move along the base 18 toward and away from the seat 12 and, in such a configuration, the seat 12 can also move along the base 18 relative to the tower 14 or can be fixed to the base 18.

With continued reference to FIGS. 2-4, the base 18 defines a track 22 and the seat 12 is operatively coupled to the track 22 to move along the track 22 away from the tower 14 to a distal position, as shown in FIG. 2, and toward the tower 14 to a proximate position, as shown in FIG. 3. For example, a carriage 24 having wheels 26 is coupled to the seat 12 and supports the seat 12 on the track 22 such that the wheels 26 roll as the seat 12 is moved between the proximate and distal positions. However, it should be appreciated that the track 22 and the seat 12 can be configured in any manner to accomplish relative movement between the seat 12 and the track 22 without departing from the nature of the present invention. The seat 12 can be moved along the track 22 by force manually applied by the occupant 20. Alternatively, a motor (not shown) can move the seat 12 relative to the track 22.

The track 22 biases the seat 12 toward the tower 14. With reference to FIGS. 2 and 3, the track 22 can include a first section 28 and a second section 30 ramping downwardly from the first section 28 toward the tower 14. The first section 28 supports the seat 12 in the distal position. In other words, when in the distal position, the seat 12 remains at rest in the distal position until a force, such as, for example, a force exerted by the occupant 20 or a force exerted by a motor, moves the seat 12 along the track 22 toward the proximate position.

Typically, the first section 28 of the track 22 is horizontal such that the seat 12 is selectively maintained along the first section 28 of the track 22 at the distal position absent a force toward the proximate position. Alternatively, the first section 28 could ramp downwardly away from the second section 30 such that the seat 12 is biased toward the distal position when the seat 12 is disposed along the first section 28. In such a configuration, a force, such as a force exerted by the occupant 20, is applied to the seat 12 to overcome the bias of the ramped first section 28 to move the seat 12 toward the proximate position.

When the seat 12 is moved along the track 22 to the second section 30, the second section 30 biases the seat 12 toward the proximate position due to the downward ramping configuration of the second section 30. In other words, when the wheels 26 are moved to the second section 30 of the track 22, the force of gravity pulls the wheels 26 downwardly along the second section 30 toward the proximate position. When in the proximate position, a force, such as by the occupant 20, can be applied to the seat 12 to overcome the bias of the ramped second section 30 and move the seat 12 toward the distal position.

The track 22 can include a third section 32 extending transversely to the second section 30 from the second section 30 toward the tower 14. As shown in FIG. 2, the third section 32 supports the seat 12 when the seat 12 is in the proximate position. Typically, the third section 32 is horizontal such that the application of a slight force on the seat 12 toward the distal position maintains the seat 12 at the intersection of the third section 32 and the second section 30, which ramps upwardly from the third section 32. The second section 30, being ramped upwardly from the third section 32, maintains the seat 12 at the intersection of the second 30 and third 32 sections when a slight force, i.e., a force insufficient to overcome the bias of the ramped second section 30, is applied to the seat 12 toward the distal position. For example, when the occupant 20 is seated on the seat 12 as shown in FIG. 3 with feet at rest on a foot rest 34, the slight force applied by the weight of the occupant 20 toward the distal position is insufficient to overcome the bias of the ramped second section 30. If the occupant 20 actively applies sufficient force against the foot rest 34 or against underlying ground, the occupant 20 can move the seat 12 upwardly along the second section 30 toward the distal position. In the alternative to the third section 32, the second section 30 can extend from the first section 28 to the tower 14.

In addition or in the alternative to the ramped configuration presented by the second section 30 of the track 22, the work station 10 could include additional features to bias the seat 12 toward the proximate position and/or the distal position. For example, the work station 10 could include a spring, a counter-weight, a pulley system, motor, etc. (not shown), between the seat 12 and the base 18 to bias the seat 12 toward the proximate position and/or the distal position.

With reference again to FIGS. 2 and 3, the base 18 can include additional wheels 36 supporting the work station 10 on the underlying ground such that the work station 10 can be rolled to different locations. The additional wheels 36 can be, for example, spring loaded such that the weight of an occupant 20 retracts the additional wheels 36 so that supports 38 that extend downwardly from the base 18 touch the underlying ground. Alternatively, as another example, the supports 38 can telescope away from the track 22 to raise the additional wheels 36 from the underlying ground and retract toward the track 22 to lower the additional wheels 36 to the underlying ground.

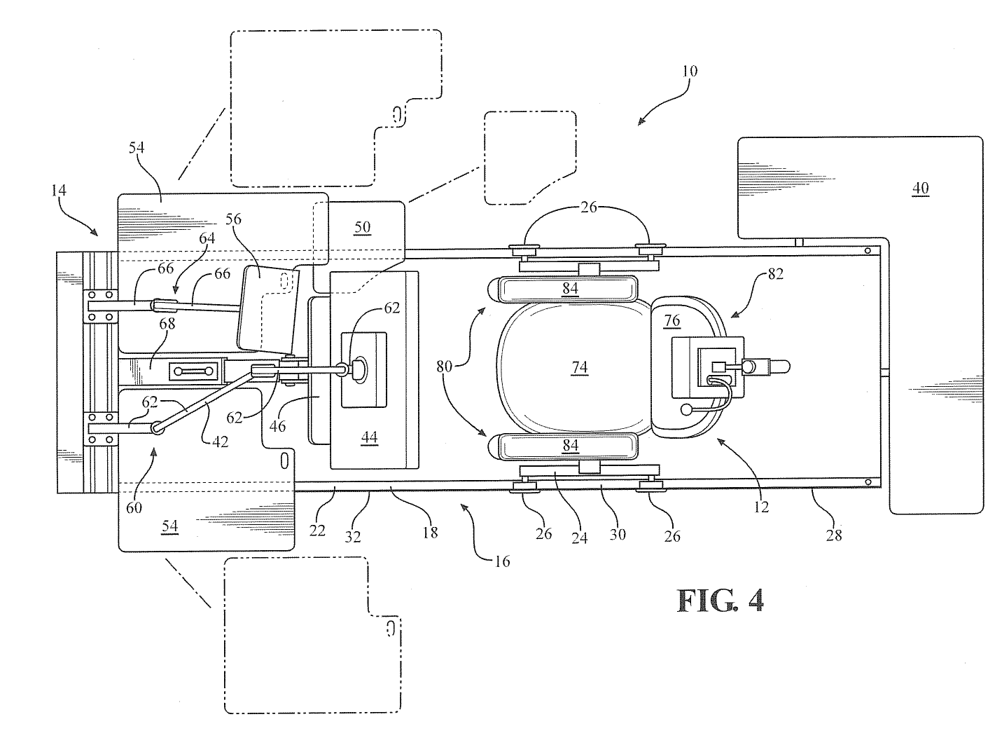

As best shown in FIG. 4, the track 22 of the work station 10 has a relatively small footprint so that multiple work stations 10 can be organized in a relatively small area. The work station 10 can include a table 40 connected to the base 18. The table 40 provides additional working area and can be accessed by the occupant 20 when the occupant 20 moves the seat 12 to the distal position. Multiple work stations 10 can be arranged around and connected to the table 40 such that the occupants 20 of the work stations 10 can share the working area provided by the table 40. The shape and size of table 40 is shown in FIG. 4 for exemplary purposes and the table 40 can be of any shape and size without departing from the nature of the present invention. As an alternative example, the table 40 can be round with multiple work stations 10 circumferentially spaced from each other about the table 40 and extending radially from the table 40. In such an embodiment, the side of the base 18 opposite the tower 14 could be adjacent and/or connected to the table 40 so that the occupants of the work stations 10 can move the seats 12 to the distal positions to interact with each other about the table 40.

The table 40 can tie together the multiple work stations 10 to form a single connected unit. Alternatively or in addition, the base 18 of each of the multiple work stations 10 can be connected together with connectors (not shown). In any event, the work station 10 has a modular configuration such that multiple work stations 10 can be assembled together for use in, for example, an office. However, it should be appreciated that the work station 10 can also be free standing and independent of any other work station.

The table 40 can be removeably connected to the work station 10, e.g., the base 18, by, for example, clips, threaded fasteners, telescopic engagement, etc. In addition, or in the alternative, to the table 40, the work station 10 can include bookcases, file cabinets, screens, etc., that are removeably connected to the workstation. By being removeably connected, the table 40, bookcases, file cabinets, screens, etc., make the work station 10 modular, i.e., one can choose which components to removeably connect to the work station 10.

The base 18 and the track 22 can be collapsible for storage, transportation, etc. For example, as shown in FIG. 3A, the base 18 and the track 22 can include a hinge 166 about which the base 18 and the track 22 collapse to reduce the footprint of the work station 10 when not in use. Alternatively, for example, the base 18 and the track 22 can each include telescopic extensions that can be removed when the work station 10 is not in use to reduce the footprint of the work station 10.

With reference to FIGS. 1-4, as set forth above, the tower 14 includes apparatus 16 for supporting components of a computer. The apparatus 16 typically extend from the tower 14 toward the seat 12 overhanging the base 18.

The apparatus 16 can, for example, be configured for use with a desktop computer and can include a monitor support 42 for supporting a monitor 44 of the computer, a keyboard support 46 for supporting a keyboard 48 of the computer, and a mouse support 50 for supporting a computer mouse 52. In such a configuration, the tower 14 can also include a ledge (not shown) for supporting a case that houses the processing unit, motherboard, etc., of the desktop computer. Alternatively, the case can be supported on the underlying ground. The monitor support 42 can alternatively support a device other than a monitor such as, for example, a gaming device like a slot machine.

The apparatus 16 can also support other components and can include a working surface 54 for supporting a book, papers, a writing utensil, etc., a work piece support 56 for supporting a work piece such as a book, papers, etc. or for supporting a laptop computer or an second monitor, a lamp support (not shown) for supporting a lamp, and a telephone support (not shown) for supporting a telephone. The apparatus 16 can also include a book shelf (not shown), a file cabinet (not shown), and a supply holder (not shown). It should be appreciated that the above description of the apparatus 16 is exemplary and is not meant to be limiting; the apparatus 16 can include one or more of the components described above and/or any sort of support or surface for use by the occupant 20 without departing from the nature of the present invention.

It should be appreciated that the work piece support 56 can be a laptop computer support. Also, while FIG. 1 depicts a computer mouse 52 supported on the mouse support 50, alternatively, a joystick or other screen cursor (not shown) can be supported on the mouse support 50, i.e., the mouse support 50 can be a joystick support. A joystick or other screen cursor can also be supported by the monitor support 46.

The tower 14 includes an upright frame 58 coupled to the base 18. The apparatus 16 is adjustable relative to the tower 14. Specifically, at least one, and typically all, of the monitor support 42, the keyboard support 46, the mouse support 50, and the work piece support 56 is moveable relative to the upright frame 58 toward and away from the seat 12 and/or is rotatable relative to the upright frame 58 and the seat 12. The tower 14 can be removeably attached to the base 18 so that the tower 14 can be removed from the base during storage, transport, etc.

Each apparatus 16 is moveable relative to the upright frame 58 in at least one, and typically multiple degrees of freedom. As one example, with reference to FIG. 2, the monitor support 42 can include movements in five degrees of freedom, as indicated by arrows. The monitor support 42 can include a monitor linkage 60 extending from the upright frame 58 to the monitor 44 to support the monitor 44 on the upright frame 58. The monitor linkage 60 may include links 62 that are rotatably coupled to each other about five different axes of rotation to define the five degrees of freedom. With continued reference to FIG. 2, some of the axes about which the links rotate extend in different directions to add to adjustability of the monitor linkage 60. The monitor linkage 60 may include four links 62 connected to each other with pin joints. Alternatively, the links 62 could be joined with other types of joints such as ball and socket joints, telescoping joints, etc. It should be appreciated that the monitor linkage 60 can include more or less than four links 62 to define varying numbers of degrees of freedom. In addition to or in the alternative to the monitor linkage 60, the monitor support 42 can include telescoping tubes (not shown) for moving the monitor 44 toward and away from the seat 12.

With reference again to FIG. 2, the work piece support 56 can include movements in four degrees of freedom, as indicated by arrows. A support linkage 64 extends from the upright frame 58 to the work piece support 56 to support the work piece support 56 on the upright frame 58. The support linkage 64 includes links 66 that are rotatably coupled to each other about four different axes of rotation to define the four degrees of freedom. With continued reference to FIG. 2, some of the axes about which the links 66 rotate extend in different directions to add to adjustability of the support linkage 64. The support linkage 64 includes three links 66 connected to each other with pin joints. Alternatively, the links 66 could be joined with other types of joints such as ball and socket joints, telescoping joints, etc. It should be appreciated that the support linkage 64 can include more or less than three links 66 to define varying numbers of degrees of freedom.

With continued reference to FIG. 2, the keyboard support 46 can include movements in two degrees of freedom, as indicated by arrows. Specifically, the keyboard support 46 includes a telescoping keyboard support arm 68 defining one degree of freedom, i.e., translation along the telescoping arm 68, and a rotatable keyboard surface 70 defining a second degree of freedom.

Still referring to FIG. 2, the mouse support 50 can include movement in three degrees of freedom, as indicated by arrows. Specifically, the mouse support 50 includes a telescoping mouse support arm 72 defining one degree of freedom, i.e., translation along the telescoping arm 72. The mouse support 50 is also rotatable about two spaced axes defining the second and third degrees of freedom.

The working surface 54 is configured to be easily removeable from the upright frame 58, as shown in FIG. 4. For example, the working surface 54 can be attached to the upright frame 58 with clips or removeable fasteners (not shown) to allow for quick disassembly. In addition, the apparatus 16 are configured to be easily removeable from the upright frame 58 such as the mouse support 50 as shown in FIG. 4. As such, the working surface 54 and/or the apparatus 16 can be removed to reduce the size of the work station 10 for ease of shipping and/or storage. The base 18 can be sized to fit through doorways, such as, for example, a standard 32″ doorway, such that the base 18 can be easily wheeled through doorways when some or all of the apparatus 16 are removed.

The seat 12 includes a seat bottom 74 and a seat back 76 extending upwardly from the seat bottom 74. The seat back 76 and the seat bottom 74 can be fixed in position relative to each other. Alternatively, the seat back 76 and the seat bottom 74 can be selectively pivotable relative to each other such that the seat back 76 can be selectively reclined relative to the seat bottom 74. The seat bottom 74 and the seat back 76 are typically upholstered.

With reference to FIG. 2, a pedestal 78 extends along an axis A from the base 18 transversely to the track 22 to support the seat bottom 74. Typically, the pedestal 78 is carried by the carriage 24. The seat bottom 74 is rotatable about the axis A. Typically, the pedestal 78 is split into two portions with the portions rotatably coupled to each other. Alternatively, the pedestal 78 can be rotatably connected to the carriage 24 and/or the seat bottom 74 such that the seat 12 can rotate about the axis.

The seat bottom 74 is pivotally coupled to the pedestal 78 such that the seat 12 can pivot between an upright position shown in FIG. 2 and a reclined position shown in FIG. 3. For example, the foot rest 34 can be connected to the upright frame 58 such that the occupant 20 can rest his/her feet on the foot rest 34 and shift his/her weight toward the seat back 76 to pivot the seat 12 to the reclined position. The seat bottom 74 can be moved to the reclined position with the use of a motor (not shown). The pedestal 78 can also be moveable to raise and lower the seat bottom 74 relative to the base 18.

With reference to FIGS. 2 and 3, the seat 12 can be moveable in four degrees of freedom, as indicated by arrows shown in FIG. 2. Specifically, the seat 12 can move toward and away from the tower 14 to define one degree of freedom. In addition, the seat bottom 74 can pivot between the upright and reclined position to define a second degree of freedom. The seat bottom 74 can also rotate about the axis to define a third degree of freedom and can be raised or lowered on the pedestal 78 to define a fourth degree of freedom.

With reference to FIG. 3, the seat 12 has seat components for supporting an occupant 20 including an armrest 80 and a headrest 82. The armrest 80 extends upwardly from the seat bottom 74 to support the arms of the occupant 20. Typically, the seat 12 includes two armrests 80, as shown in FIG. 1. The headrest 82 extends upwardly from the seat back 76 to support the head of the occupant 20.

Both armrests 80 are typically minor images of each other such that both armrests 80 function identically. Alternatively, the seat 12 can have only one armrest 80 or, in the case of two armrests 80, the armrests 80 can have different configurations and can function differently. For simplicity, a single armrest 80 is described below and it should be appreciated that, in the embodiment having two armrests 80, the other armrest 80 can be identical to or different than the armrest 80 described below.

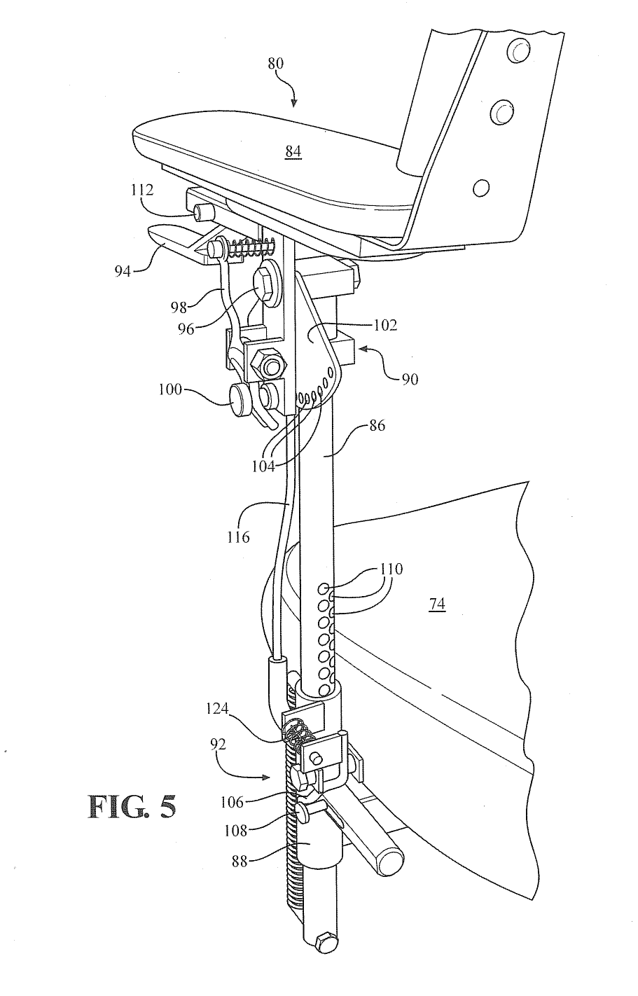

With reference to FIG. 5, the armrest 80 can include an armrest pad 84, an armrest rod 86 coupled to the armrest pad 84, and an armrest sleeve 88 receiving the armrest rod 86. The armrest sleeve 88, for example, is typically affixed to the seat bottom 74. As set forth further below, the armrest pad 84, the armrest rod 86, and the armrest sleeve 88 are selectively adjustable relative to each other for repositioning the armrest 80 relative to the keyboard support 46 such that the occupant 20 can adjust the armrest pad 84 to support his/her arm in an ergonomically correct posture for typing on the keyboard 48. Specifically, the armrest 80 can be adjusted to the keyboard support 46 providing an orientation between the armrest 80 and the keyboard support 46 to achieve the ergonomically correct posture, as shown in FIG. 3. To achieve the ergonomically correct posture, the armrest 80 and the keyboard support 46 are side by side such that the occupant's 20 hands easily and freely reach the keyboard 48 on the keyboard support 46.

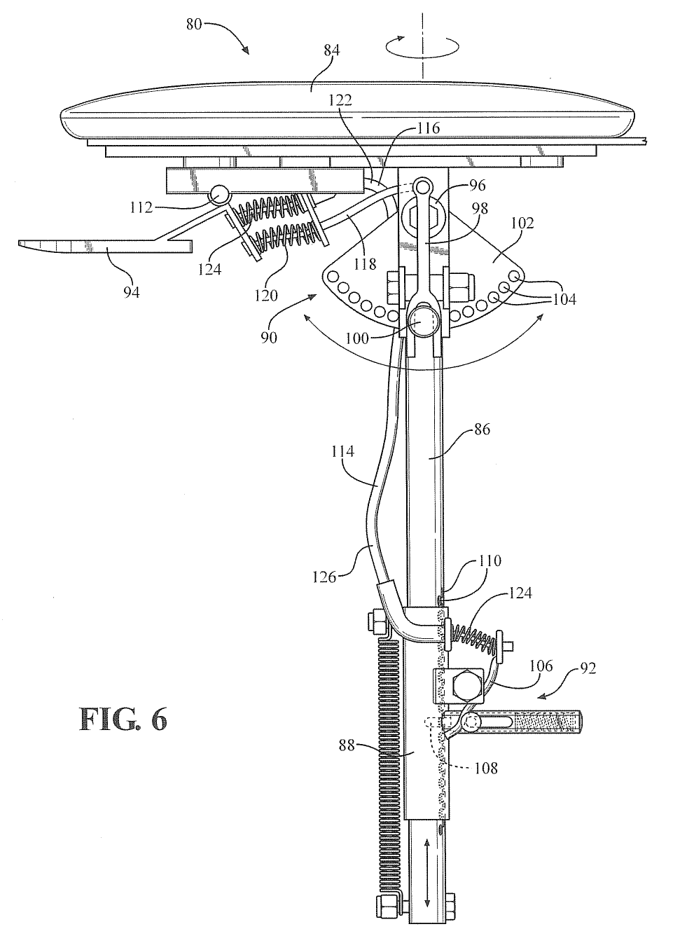

The armrest 80 can include a first armrest adjustment device 90 and a second armrest adjustment device 92 for adjusting the armrest 80. With reference to FIGS. 5 and 6, the first armrest adjustment device 90 selectively interconnects the armrest pad 84 and the armrest rod 86 for locking the armrest pad 84 and the armrest rod 86 after adjustment. The second armrest adjustment device 92 selectively interconnects the armrest rod 86 and the armrest sleeve 88 for locking the armrest rod 86 and the armrest sleeve 88 after adjustment.

An armrest lever 94 is operatively connected to the first armrest adjustment device 90 and to the second armrest adjustment device 92 to selectively unlock the first 90 and second 92 armrest adjustment devices to allow adjustment of the armrest 80 and to selectively lock the first 90 and second 92 armrest adjustment devices to prevent adjustment of the armrest 80. Specifically, the armrest lever 94 is moveable between an unlocked position and a locked position. When moved to the unlocked position, the armrest lever 94 simultaneously unlocks the first 90 and second 92 armrest adjustment devices to allow for adjustment of the armrest 80. When moved to the locked position, the armrest lever 94 simultaneously locks the first 90 and second 92 armrest adjustment devices to prevent adjustment of the armrest 80.

The armrest pad 84 is pivotally connected to the armrest rod 86 about a pin 96. The first armrest adjustment device 90 includes a first pivot pin 98 and a first engagement pin 100 coupled to the armrest pad 84 and a plate 102 mounted to the armrest rod 86. The plate 102 defines a plurality of holes 104 capable of receiving the first engagement pin 100. The plurality of holes 104 are defined along an arc about the pin 96.

When the first engagement pin 100 is engaged with one of the plurality of holes 104 of the plate 102, this engagement prevents relative pivoting between the armrest pad 84 and the armrest rod 86. When the first engagement pin 100 is disengaged with the holes 104 of the plate 102, the armrest pad 84 and the armrest rod 86 can freely pivot relative to each other. Typically, the first armrest adjustment device 90 is spring loaded such that the first engagement pin 100 is engaged with one of the plurality of holes 104 in the plate 102 when at rest.

The armrest rod 86 is slideably received by the armrest sleeve 88. The second armrest adjustment device 92 includes a second pivot pin 106 and a second engagement pin 108 coupled to the armrest sleeve 88. The armrest rod 86 defines a plurality of holes 110 capable of receiving the second engagement pin 108. The holes 110 are spaced in multiple directions such that the armrest rod 86 can be moved to multiple positions to receive the second engagement pin 108.

When the second engagement pin 108 is engaged with one of the plurality of holes 110 of the armrest rod 86, this engagement prevents relative pivoting between the armrest rod 86 and the armrest sleeve 88. When the second engagement pin 108 is disengaged with the holes 110 of the armrest rod 86, the armrest rod 86 and the armrest sleeve 88 can freely slide relative to each other. Typically, the second armrest adjustment device 92 is spring loaded such that the second engagement pin 108 is engaged with one of the plurality of holes 110 in the armrest rod 86 when at rest.

The armrest lever 94 pivots about a pivot point 112. The armrest lever 94 is connected to the first armrest adjustment device 90 with a first cable system 114 and is connected to the second armrest adjustment device 92 with a second cable system 116. The first 114 and second 116 cable systems can be of the type commonly referred to as a Bowden cable. The armrest lever 94 could be further defined as a pair of levers connected to the first cable system 114 and the second cable system 116, respectively.

The first cable system 114 includes a first sheath 118 fixed to the armrest pad 84 and to the armrest sleeve 88. A first cable 120 extends through a first sheath 118 from the armrest lever 94 to the first armrest adjustment device 90. The second cable system 116 includes a second sheath 122 fixed to the armrest pad 84 and the armrest rod 86. A second cable 124 extends through the second sheath 122 from the armrest lever 94 to the second armrest adjustment device 92.

As set forth above, the first 100 and second 108 engagement pins are typically spring loaded to engage the holes 104, 110 in the plate 102 and armrest rod 86, respectively, when at rest. The armrest lever 94 can be pivoted about the pivot point 112 to simultaneously pull the first 120 and second 124 cables through the first 118 and second 122 sheaths thereby pivoting the first 98 and second 106 pivot pins and disengaging the first 100 and second 108 engagement pins from the holes 104, 110 in the plate 102 and armrest rod 86, respectively. When the first 98 and second 106 pivot pins are disengaged from the holes 104, 110 in the plate 102 and the armrest rod 86, the armrest pad 84 and the armrest rod 86 can pivot relative to each other and the armrest rod 86 and the armrest sleeve 88 can rotate and slide relative to each other such that the occupant 20 can adjust the armrest pad 84 to an ergonomically correct position. When the occupant 20 properly adjusts the armrest 80, the armrest lever 94 is released and the first 100 and second 108 engagement pins engage holes 104, 110 on the plate 102 and the armrest rod 86, respectively, to lock the armrest 80 in position.

With reference to FIG. 6, the armrest 80 is moveable in three degrees of freedom, as indicated by arrows. Specifically, when the first 90 and second 92 adjustment devices are unlocked, the armrest pad 84 and the armrest rod 86 can pivot relative to each other to define one degree of freedom. The armrest rod 86 can slide vertically and can rotate relative to the armrest sleeve 88 to define a second and third degree of freedom. FIGS. 2 and 3 illustrate varying positions of the armrest 80.

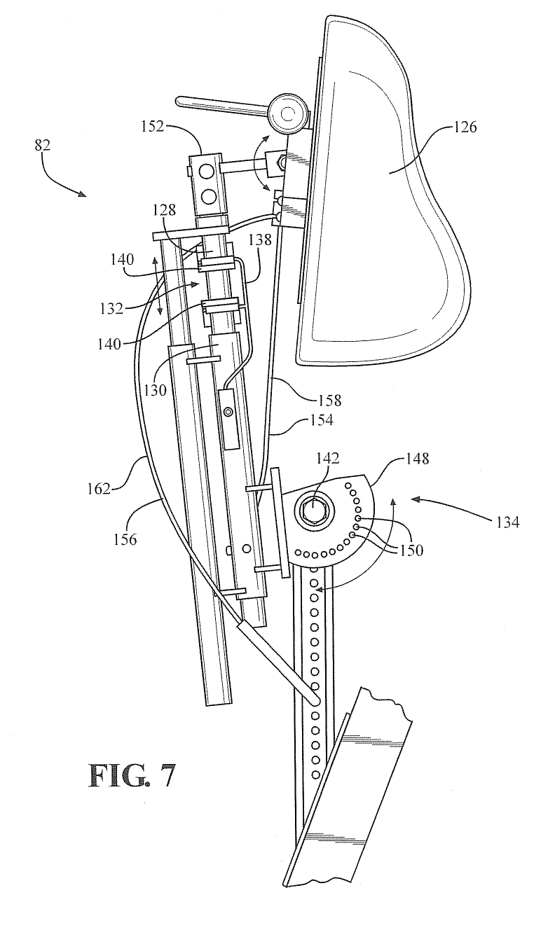

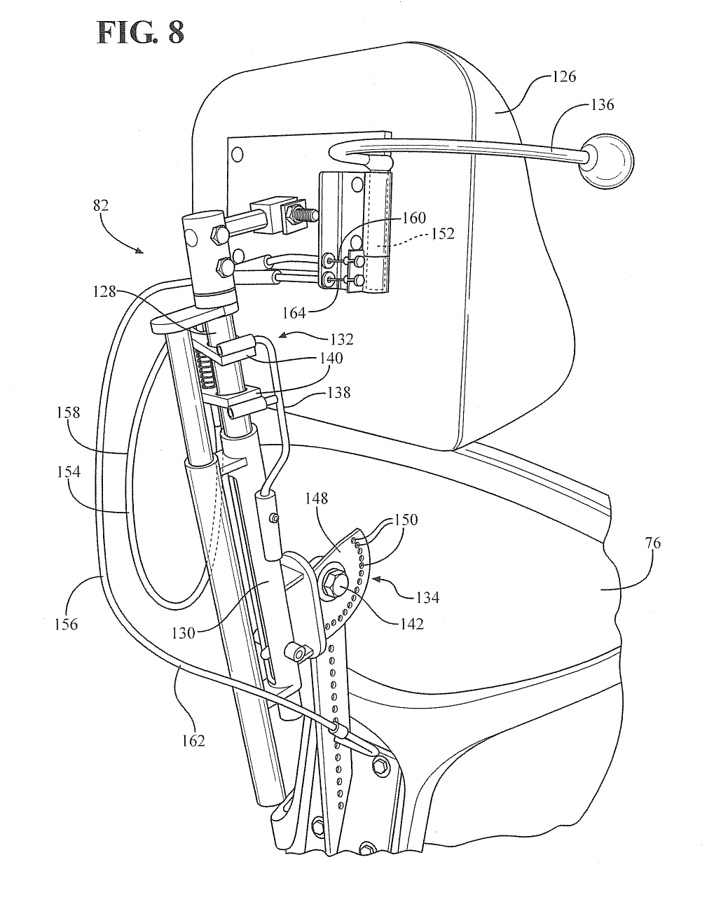

With reference to FIGS. 7 and 8, the headrest 82 can include a headrest pad 126, a headrest rod 128 coupled to the headrest pad 126, and a headrest sleeve 130 receiving the headrest rod 128. Typically the headrest sleeve 130 is affixed to the seat bottom 74 or the seat back 76. As set forth further below, the headrest pad 126, the headrest rod 128, and the headrest sleeve 130 are selectively adjustable relative to each other for repositioning the headrest 82 relative to the apparatus 16, such as the monitor support 42, such that the occupant 20 can adjust the headrest pad 126 to support his/her head in an ergonomically correct posture for viewing the monitor 44. The headrest 82 can be adjustable relative to the monitor support 42 providing an ergonomically correct posture. This ergonomically correct posture reduces eye strain and neck and back fatigue because the occupant's eyes are already facing the monitor 44 such that the occupant 20 need not lean his/her neck and/or back to properly view the monitor 44.

As one example, the headrest 82 and the monitor support 42 can be adjusted to be substantially parallel orientation between the headrest 82 and the monitor 44 in a facing relationship, as shown in FIG. 3, to achieve the ergonomically correct posture. In other words, the headrest 82 and the monitor 44 are spaced from each other and face each other in generally parallel planes. However, the headrest 82 and the monitor support 42 can be adjusted to any position relative to each other to provide the ergonomically correct posture sought by the occupant 20.

The orientation of the headrest 82 and the monitor support 42 is independent from the orientation between the armrest 80 and keyboard support 46. In other words, the orientation of the armrest 80 and the keyboard support 46 can be changed independently of the orientation of the headrest 82 and the monitor support 42.

The headrest 82 can include a first headrest adjustment device 132 and a second headrest adjustment device 134. With reference to FIGS. 7 and 8, the first headrest adjustment device 132 selectively interconnects the headrest rod 128 and the headrest sleeve 130 for locking the headrest rod 128 and the headrest sleeve 130 after adjustment. The second headrest adjustment device 134 selectively interconnects the headrest sleeve 130 and the seat 12 for locking the headrest sleeve 130 and the seat 12 after adjustment.

A headrest lever 136 is connected to the first headrest adjustment device 132 and to the second headrest adjustment device 134 to selectively unlock the first and second headrest adjustment devices 134 to allow adjustment of the headrest 82 and to selectively lock the first 132 and second 134 headrest adjustment devices to prevent adjustment of the headrest 82. Specifically, the headrest lever 136 is moveable between an unlocked position and a locked position. When moved to the unlocked position, the headrest lever 136 simultaneously unlocks the first 132 and second 134 headrest adjustment devices to allow for adjustment of the headrest 82. When moved to the locked position, the headrest lever 136 simultaneously locks the first 132 and second 134 headrest adjustment devices to prevent adjustment of the headrest 82.

The headrest pad 126 is typically pivotally connected to the headrest rod 128 such that the headrest pad 126 can be pivoted relative to the headrest rod 128. Typically, the connection between the headrest pad 126 and the headrest rod 128 is a friction fit such that a sufficient force can be applied to the headrest pad 126 to move the headrest pad 126 relative to the headrest rod 128.

The first headrest adjustment device 132 includes a bracket 138 mounted to the headrest sleeve 130 and supporting a pair of friction plates 140 that receive the headrest rod 128. The friction plates 140 are pivotable relative to the bracket 138 to selectively engage and disengage the headrest rod 128. When the friction plates 140 are in a generally parallel relationship, the headrest rod 128 can freely slide through the friction plates 140. When the friction plates 140 are moved to a transverse relationship, the friction plates 140 lock against the headrest rod 128 and prevent movement between the headrest rod 128 and the headrest sleeve 130. A spring is disposed between the friction plates 140 to bias the friction plates toward the transverse relationship.

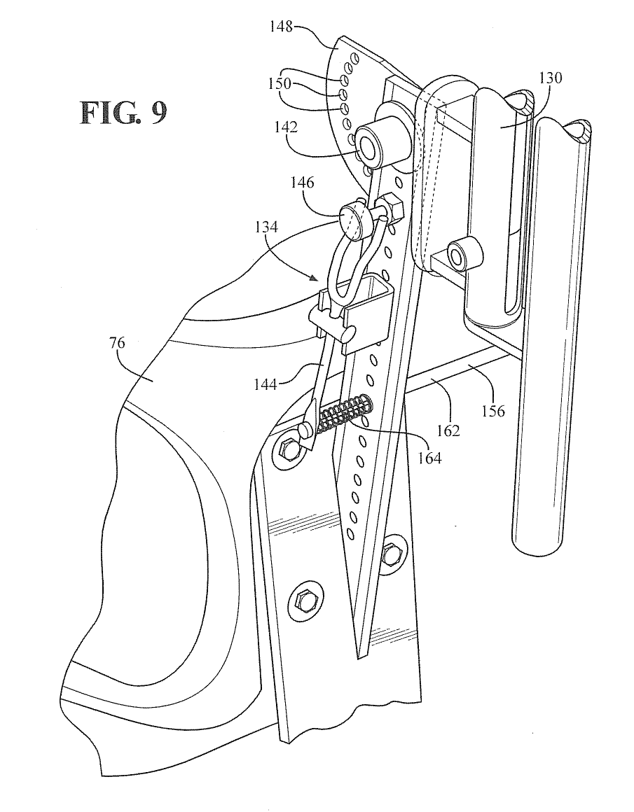

With reference to FIG. 9, the headrest sleeve 130 is pivotally connected to the seat back 76 about a pin 142. The second headrest adjustment device 134 includes a third pivot pin 144 and a third engagement pin 146 coupled to the seat 12 and a second plate 148 mounted to the headrest sleeve 130. The second plate 148 defines a plurality of holes 150 capable of receiving the third engagement pin 146. The plurality of holes 150 are defined along an arc about the pin 142.

When the third engagement pin 146 is engaged with one of the plurality of holes 150 of the second plate 148, this engagement prevents relative pivoting between the headrest sleeve 130 and the seat 12. When the third engagement pin 146 is disengaged with the holes 150 of the second plate 148, the headrest sleeve 130 and the seat 12 can freely pivot relative to each other. Typically, the second headrest adjustment device 134 is spring loaded such that the third engagement pin 146 is engaged with one of the plurality of holes 150 in the second plate 148 when at rest.

With reference to FIG. 8, the headrest lever 136 pivots about a pivot point 152. The headrest lever 136 is connected to the first headrest adjustment device 132 with a third cable system 154 and is connected to the second headrest adjustment device 134 with a fourth cable system 156. The third 154 and fourth 156 cable systems can be of the type commonly referred to as a Bowden cable. The headrest lever 136 could be further defined as a pair of levers connected to the third cable system 154 and the fourth cable system 156, respectively.

The third cable system 154 includes a third sheath 158 fixed to the headrest pad 126 and to the headrest rod 128. A third cable 160 extends through a third sheath 158 from the headrest lever 136 to the first headrest adjustment device 132. The fourth cable system 156 includes a fourth sheath 162 fixed to the headrest pad 126 and the seat 12. A fourth cable 164 extends through the fourth sheath 162 from the headrest lever 136 to the second headrest adjustment device 134.

As set forth above, the friction plates 140 and the third engagement pin 146 are typically spring loaded to be locked when at rest. The headrest lever 136 can be pivoted to simultaneously pull the third 160 and fourth 164 cables through the third 158 and fourth 162 sheaths thereby moving the friction plates 140 to the parallel relationship and disengaging the third engagement pin 146 from the holes 150 in the second plate 148. When the friction plates 140 are in the parallel relationship and the third engagement pin 146 is disengaged from the holes 150 in the second plate 148, the headrest rod 128 and the headrest sleeve 130 can slide relative to each other and the headrest sleeve 130 and the seat 12 can pivot relative to each other such that the occupant 20 can adjust the headrest 82 to an ergonomically correct position. When the occupant 20 properly adjusts the headrest 82, the headrest lever 136 is released and the friction plates 140 move to the transverse relationship and the third engagement pin 146 engages one of the holes 150 on the second plate 148 to lock the headrest 126 in position.

With reference to FIG. 7, the headrest 82 is moveable in three degrees of freedom, as indicated by arrows. Specifically, the headrest pad 126 can pivot relative to the headrest rod 128 to define a first degree of freedom. When the first 132 and second 134 headrest adjustment devices are unlocked, the headrest rod 128 can slide relative to the headrest sleeve 130 to define a second degree of freedom and the headrest sleeve 130 can pivot relative to the seat 12 to define a third degree of freedom. FIGS. 2 and 3 illustrate varying positions of the headrest 82.

In use, the occupant 20 sits in the seat 12 and moves the seat 12, either manually or powered, to the proximate position shown in FIG. 3. Since the apparatus 16, such as the monitor support 42 and the keyboard support 46, extend from the tower 14 toward the seat 12 overhanging the base 18, the occupant 20 is forced to move the seat 12 to the reclined position shown in FIG. 3. In other words, the configuration of the work station 10 forces the occupant 20 to move the seat 12 to the reclined position in order to achieve an ergonomically correct posture. When the seat 12 is in the reclined position, the occupant 20 can adjust the any or all of the apparatus 16 to achieve ergonomically correct posture. For example, the keyboard support 46 and the armrest 80 can be adjusted relative to each other so that the occupant 20 does not strain to use the keyboard 48. As another example, the monitor support 42 and the headrest 82 can be adjusted relative to each other so the occupant 20 does not strain to view the monitor 44.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A work station comprising:
a base;
a seat and a tower each being cooperatively connected to said base thereby providing an adjustable interaction between said seat and said tower, said tower supporting a keyboard support and said seat having an armrest for supporting an occupant;
at least one armrest adjustment device disposed between said seat and said armrest and being moveable between an unlocked position to allow for adjustment of said armrest relative to said seat to an ergonomically correct position relative to said keyboard support and to a locked position to lock said armrest in said ergonomically correct position; and
an armrest lever operatively connected to said at least one armrest adjustment device to move said at least one armrest adjustment device between said unlocked position and said locked position.

2. The work station as set forth in claim 1 wherein said armrest includes an armrest pad, an armrest rod coupled to said armrest pad, and an armrest sleeve receiving said armrest rod and wherein said armrest pad, said armrest rod, and said armrest sleeve are selectively adjustable relative to each other for repositioning said armrest.

3. The work station as set forth in claim 2 wherein the at least one armrest adjustment device includes a first armrest adjustment device selectively interconnecting said armrest pad and said armrest rod for locking said armrest pad and said armrest rod after adjustment and a second armrest adjustment device selectively interconnecting said armrest rod and said armrest sleeve for locking said armrest rod and said armrest sleeve after adjustment.

4. The work station as set forth in claim 3 wherein said armrest lever is connected to said first armrest adjustment device and to said second armrest adjustment device and wherein said armrest lever simultaneously unlocks said first and second armrest adjustment devices when moved to said unlocked position and simultaneously locks said first and second armrest adjustment devices when moved to said locked position.

5. The work station as set forth in claim 1 further comprising a headrest supported by said seat, a headrest adjustment device disposed between said headrest and said seat, and a headrest lever operatively connected to said at least one headrest adjustment device to move said at least one headrest adjustment device between an unlocked position and a locked position.

6. The work station as set forth in claim 1 wherein said headrest includes a headrest pad, headrest rod coupled to said headrest pad, and a headrest sleeve receiving said headrest rod and wherein said headrest pad, said headrest rod, and said headrest sleeve are selectively adjustable relative to each other for repositioning said headrest.

7. The work station as set forth in claim 1 wherein said keyboard support is moveable relative to said tower toward and away from said seat and/or is rotatable relative to said tower.

8. The work station as set forth in claim 1 further comprising a monitor support extending from said tower and being moveable relative to said tower toward and away from said seat and/or being rotatable relative to said tower.

9. The work station as set forth in claim 1 wherein said seat includes a seat bottom and a pedestal extending along an axis from said base to said seat bottom with said seat bottom rotatable about said axis.

10. The work station as set forth in claim 1 wherein said base defines a track with said seat moveable along said track toward and away from said tower.

11. A work station comprising:
a track;
a tower coupled to said track and including apparatus for supporting components of a computer including at least one of a monitor support and a keyboard support;
a seat operatively coupled to said track to move along said track toward said tower to a proximate position and away from said tower to a distal position, said seat being rotatable about an axis extending transversely to said track; and
said track including a first section and a second section ramping downwardly from said first section toward said tower such that said first section supports said seat in said distal position and such that said second section biases said seat toward said proximate position when said seat is moved along said track to said second section.

12. The work station as set forth in claim 11 wherein said first section of said track is horizontal such that said seat is selectively maintained along said first section of said track at said distal position.

13. The work station as set forth in claim 11 wherein said track includes a third section extending transversely to said second section from said second section toward said tower with said third section supporting said seat when said seat is in said proximate position.

14. The work station as set forth in claim 11 further comprising wheels coupled to said seat and supporting said seat on said track for rolling as said seat is moved between said proximate and distal positions.

15. The work station as set forth in claim 11 further comprising an armrest including an armrest pad, an armrest rod coupled to said armrest pad, and an armrest sleeve coupled to said seat and receiving said armrest rod for repositioning said armrest relative to said seat.

16. The work station as set forth in claim 15 further comprising a first armrest adjustment device selectively interconnecting said armrest pad and said armrest rod for locking said armrest pad and said armrest rod after adjustment and a second armrest adjustment device selectively interconnecting said armrest rod and said armrest sleeve for locking said armrest rod relative and said armrest sleeve after adjustment.

17. The work station as set forth in claim 16 further comprising an armrest lever connected to said first armrest adjustment device and to said second armrest adjustment device and moveable to an unlocked position simultaneously unlocking said first and second armrest adjustment devices to allow for adjustment of said armrest and to a locked position simultaneously locking said first and second armrest adjustment devices to prevent adjustment of said armrest.

18. The work station as set forth in claim 11 further comprising a headrest including a headrest pad, headrest rod coupled to said headrest pad, and a headrest sleeve coupled to said seat and receiving said headrest rod for adjusting said headrest relative to said seat.

19. The work station as set forth in claim 18 further comprising a first headrest adjustment device selectively interconnecting said headrest rod and said headrest sleeve for locking said headrest rod and said headrest sleeve after adjustment and a second headrest adjustment device selectively interconnecting said headrest sleeve and said seat for locking said headrest sleeve and said seat after adjustment.

20. The work station as set forth in claim 19 further comprising a headrest lever connected to said first headrest adjustment device and to said second headrest adjustment device and moveable to an unlocked position for simultaneously unlocking said first and second headrest adjustment devices to allow for adjustment of said headrest and to a locked position for simultaneously locking said first and second headrest adjustment devices to prevent adjustment of said headrest.
